(19) United States
(12) Patent Application Publication
(10) Pub. No.: US 2025/0075087 A1
(43) Pub. Date: Mar. 6, 2025

(54) MULTI-LAYER MULTI-FUNCTIONAL SMART COATING

(71) Applicant: Saudi Arabian Oil Company, Dhahran (SA)

(72) Inventors: Abderrahim Fakiri, Dhahran (SA); Christian M. Canto Maya, Dhahran (SA); Sangki Chi, Dhahran (SA); Senhat Mohammed Alotaibi, Dammam (SA); Shaj K. Manjalivalapil, Abqaiq (SA); Mohammed Ahmad Al-Omair, Al-Hasa (SA); Ibrahim Aloqalaa, Dhahran (SA)

(21) Appl. No.: 18/461,908

(22) Filed: Sep. 6, 2023

(51) Int. Cl. C09D 5/08; C09D 7/40; C09D 7/61; C09D 201/02

(52) U.S. Cl. CPC C09D 5/084; C09D 7/61; C09D 7/66; C09D 201/02

(57) ABSTRACT

A system and a method for protecting a metal surface from corrosion using a multilayer protective coating are provided. The multilayer protective coating includes a barrier layer and a corrosion inhibitor layer. The corrosion inhibitor layer includes particles that include a corrosion inhibitor.

### TECHNICAL FIELD

This disclosure relates to methods of protecting a metal with a multilayer coating.

### BACKGROUND

Coatings, both active and passive, are widely used for corrosion protection. The primary function of passive coatings are to provide a protective layer, or barrier, to the metal surface underneath the coating. The barrier blocks contact of oxygen and water with the metal surface and resists ion movement at the metal-electrolyte interface. However, during prolonged exposure to aggressive environments, the passive coating is susceptible to mechanical and chemical deterioration. For example, openings, such as micro-pores and cracks, may develop in the surface of coating. The openings can propagate, exposing the metal substrate to the environment which leads to ion penetration through these defects to the metal surface. Over time, this will cause corrosion of the underlying metals.

Active coatings provide both a barrier and active corrosion protection to the metal surface. In many cases, this type of coating has corrosion inhibitors incorporated into a barrier layer to decrease the corrosion rate when the barrier layer starts deteriorating. Thus, active coatings have a dual role, acting both as a barrier and as a corrosion inhibitor. However, the effect of the corrosion inhibitor is temporary, as the active agents are consumed or leach from the active coating. Further, poor compatibility with a polymeric matrix, or binder, and possible reactions between the active agents and polymeric matrix can cause the disordered and uncontrolled release of the incorporated active species, which will further degrade the coating performance. As result, the active coating may rapidly lose effectiveness, even in the absence of an aggressive environment.

### SUMMARY

An embodiment described herein provides a multilayer protective coating. The multilayer protective coating includes a barrier layer and a corrosion inhibitor layer. The corrosion inhibitor layer includes particles that include a corrosion inhibitor.

Another embodiment described herein provides a method for protecting a metal surface from corrosion. The method includes depositing a barrier layer proximate to a metal surface and depositing a corrosion inhibitor layer proximate to the barrier layer. The corrosion inhibitor layer includes particles that include a corrosion inhibitor.

### BRIEF DESCRIPTION OF DRAWINGS

FIGS. 1A and 1B are drawings comparing a smart coating to the multilayer smart coating described in examples herein.

FIGS. 2A-2C are drawings of different shapes of containers that may be used in the high load smart coating.

FIGS. 3A and 3B are schematic drawings of the increase in loading for containers 102 between a smart coating 302 and a high load smart coating 304.

FIGS. 4A-4D are drawings that show different ways to adjust the operation of the high load smart coating 304.

FIG. 5 is a process flow diagram of a method 500 for protecting a metal surface from corrosion.

### DETAILED DESCRIPTION

To overcome the drawbacks of active coatings, smart coatings include corrosion inhibitors that are encapsulated to prevent the direct interaction of the inhibitive species with the coating matrix. The encapsulation of the inhibitors enable the release of inhibitive species in the right quantity, when needed, over a longer period. The encapsulated inhibitors are microcapsules or nanocapsules, which are particles containing a core surrounded by a coating layer or a shell. The microcapsules and nanocapsules that include the corrosion inhibitors are termed containers, herein.

The containers range from several nm to a few microns in size. The containers encapsulate solids, droplets of liquids, or gases, which include the corrosion inhibitors. The design of the containers plays an important role in determining the performances of the smart coatings. For example, the containers selected for chemically and mechanical stability, compatibility with the coating matrix, and loading capacity. Further, the containers should have an impermeable shell wall to prevent leakage of the active substance but release the active substance when needed.

The smart coating has to maintain its dual functionalities, barrier, and corrosion inhibition. However, the barrier function limits the loading of the containers. Aggregated containers can induce the formation of defects in the coating matrix, which allow the penetration of environmental substances to the metal surface, such as aggressive ions, which reduces the service life. Thus, to protect the barrier, the loading of containers has to be limited. Commonly, the loading capacity of containers in a smart coating is generally lower than about 20% by weight. This limits the long-term active corrosion protection in applications. For example, the loading of mesoporous silica nanocontainers should be less than about 0.7 wt. % for the coating to keep its barrier performance.

Embodiments described herein provide a multi-layer smart coating where every layer has a single function. A first layer acts as a barrier while another layer, for example, in contact with the corrosive media, acts as corrosion inhibitor. Once the barrier and corrosion inhibition functionalities are decoupled, each layer can be optimized towards individual function. Accordingly, the corrosion inhibitor layer may include a much higher level of containers without jeopardizing the barrier properties of the overall coating.

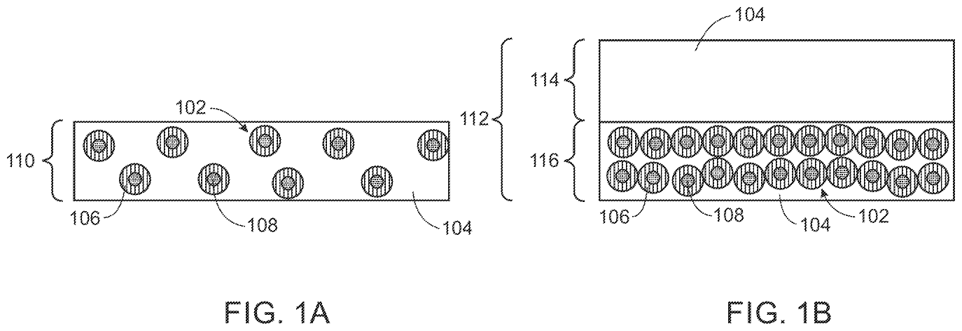

FIGS. 1A and 1B are drawings comparing a smart coating to the multilayer smart coating described in examples herein. In this drawing, the containers 102 are embedded in a matrix 104. Each of the containers 102 includes a shell 106 surrounding a core 108. As described herein, in the smart coating 110 shown in FIG. 1A, the number of containers 102 is limited to avoid promoting defects, such as the propagation of cracks, protecting the barrier functionality.

In the multi-layer smart coating 112, shown in FIG. 1B, a barrier 114 is applied to the metal surface, or to any protective metal coatings on the metal surface, and a high load smart coating 116 is applied over the barrier 114. In various embodiments, the matrix 104 in each of the barrier 114 and a high load smart coating 116 can independently be an epoxy, a polyurethane, a polyphenylene sulfide, a polyester, poly (phenylene methylene), silica, a phenolic resin, or any combination thereof.

Although the matrix 104 is shown as the same for the barrier 114 and the high load smart coating 116, the multilayer smart coating is not limited to a single type of material in the matrix 104. For example, the matrix 104 may be chosen to provide the best functionality for each application. In some embodiments, the matrix 104 for the barrier is an epoxy elastomer, while the matrix 104 for the high load smart coating 116 is a polyurethane.

Table 1 compares the combinations of coatings used for corrosion protections including the multi-layer smart coating 112. The multi-layer smart coating 112 provides two lines of defense for protecting a metal surface. The corrosion inhibitor layer of the high load smart coating 116 can be fully loaded with containers 102 that contain active corrosion inhibitor without compromising the barrier 114. The high load smart coating 116 is in direct contact with the corrosive media, and acts as a first line of defense. Once the corrosion inhibitors are released from the containers 102, they slow corrosion by interrupting the corrosion reaction or by depositing a film to prevent corrosion from growing and expanding. In some embodiments, the containers 102 may include polymeric materials that heal cracking in the matrix 104 of the high load smart coating 116. This may be in addition to any other corrosion inhibitors used in other containers 102. By not incorporating containers 102 into the barrier 114, the barrier 114 is not weakened by the containers 102 and will not deteriorate as easily.

TABLE 1
Comparison of various type of coatings

| | | | | Multi-layer |
|---|---|---|---|---|
| | Passive coating | Active coating | Smart coating | smart coating |
| Structure | | | FIG. 1A | FIG. 1B |
| Function | Passive | Passive and active | Passive and active | Passive and active |
| | | (combined) | (combined) | (separate) |
| | One line of | One line of | One line of | Multiple lines of |
| | defense | defense | defense | defense |
| | Barrier | Barrier | Barrier | Barrier |
| | | Uncontrolled | Controlled | Controlled |
| | | inhibitor release | inhibitor release | inhibitor release |
| Limitation | Barrier | Barrier | Barrier | Barrier |
| | deterioration | deterioration | deterioration | deterioration |
| | | Inhibitor loading | Inhibitor loading | |
| | | Inhibitor loss of | Compromised | |
| | | effectiveness | inhibitor loading | |
| | | | and barrier | |
| | | | properties | |
| Efficacy | 1 | 2 | 3 | 4 |

The encapsulation of the inhibitors into the containers 102 enables the release of inhibitive species on-demand in the right quantity over a longer period. Selection of the materials used as the shell 106 for the containers 102 allows the containers 102 to respond to a corrosion onset, and release the active substance as needed. There are different types of materials that can be used for the shell 106, including organic materials, inorganic materials, various types of nanoparticles, and hybrids of these materials. In various embodiments, polymers are used for the shell 106, such as polystyrene, polyurethane, and urea, and the like. Many of the materials described with respect to the matrix 104 may also be used for the shell 106. In various embodiments, inorganic materials that are used for the shell 106 include titanium dioxide, cerium dioxide, mesoporous silica, nanoclays, halloysite nanotubes, layered double hydroxide (LDH), multi-walled carbon nanotubes, hydroxyapatite, and the like. In various embodiments, hybrid structures used as the shell 106 include inorganic nanoparticles covered layer-by-layer (LBL) with polyelectrolytes, polymeric coated inorganic nanospheres or nanotubes, inorganic coated, organic hollow-nanospheres, and metal-organic framework (MOF) structures, and the like.

The encapsulated active agent of the core 108 can include inorganic inhibitors, organic inhibitors, or both. For example, in various embodiments, inorganic inhibitors used in the core 108 include cerium salts, molybdates, tungstates, and the like. In various embodiments, organic inhibitors used in the core 108, include triazole and thiazole derivatives, such as benzotriazole (BTA), mercapto-benzothiazole (MBT), and the like.

Smart coatings remain passive until external stimuli trigger the release of an inhibitor from the core 108, for example, by degradation of a shell 106. In various embodiments, the inhibitor is released by mechanical triggering (rupture), thermal stimulus, chemical damage, redox reaction, electric fields, water, pH sensitivity, pH-controlled release, desorption-controlled release, and ion-exchange controlled release, and the like. In some embodiments, the trigger is a complex internal or external trigger, such as a chemical reaction of a corrosion byproduct with the shell 106.

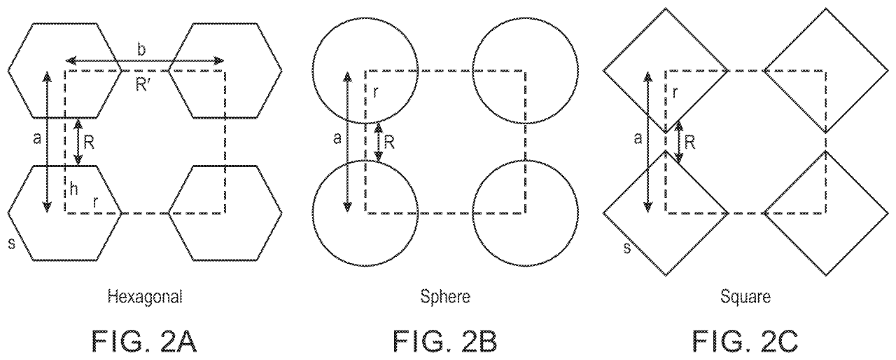

FIGS. 2A-2C are drawings of different shapes of containers that may be used in the high load smart coating. The maximum loading that can be theoretically obtained, without expanding the overall volume of the high load smart coating, depends on the shape of the nanocontainers and the packing arrangement. Assuming an ideal packing arrangement as shown in FIG. 2B, a spherical shape shows the highest loading of 78.5% by volume, followed by hexagonal shape of 75% by volume, and finally a square shape of 50% by volume. Thus, a spherical shape provides the maximum loading without increasing the volume of the high load smart coating. In various embodiments, a higher loading may be used, wherein the particles are held in place by the matrix of the high load smart coating, which acts as a binder. In these embodiments, the high load smart coating has a higher volume than a comparable smart coating with a lower loading of containers. Thus, in various embodiments, the high load smart coating includes about 10 wt. % of the containers 102, about 20 wt. %, about 40 wt. %, about 60 wt. %, or about 70 wt. %, or higher.

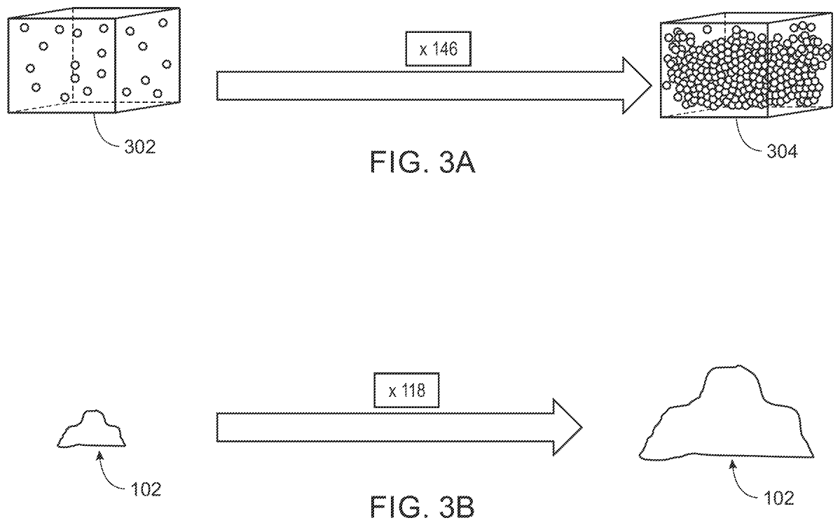

FIGS. 3A and 3B are schematic drawings of the increase in loading for containers 102 between a smart coating 302 and a high load smart coating 304. FIG. 3A illustrates the increase in the number of containers that can be included in the high load smart coating 304 over the smart coating 302. FIG. 3B illustrates the increase in the weight of the containers 102 that can be included in the high load smart coating 304 versus the weight of the containers 102 that can be included a smart coating 302 having dual functionality. In this example, the containers 102 are mesoporous silica nanocontainers having a diameter of 80 nm. As shown in some studies, and about 0.7 wt. % loading of the mesoporous silica nanocontainers is the highest loading that will not jeopardize the barrier performance of the smart coating 302. This translates into around 20 mesoporous silica nanocontainers in 1 cubic micrometer volume, as shown in FIG. 3A.

By comparison, the high load smart coating 304 used in a multi-layer structure can include up to about 2928 mesoporous silica nanocontainers with an 80 nm diameter. This corresponds to 146 times the smart coating 302 used in forming a single layer. The pore volume of the mesoporous nanocontainers silica is 1.2 mL/g. since the density of mercaptobenzothiazole (MBT) inhibitor is 1.42 g/mL, the maximum MBT loading capacity per one gram of mesoporous silica is about 1.7 g. Accordingly, 1 Kg of a single-layer coating made from the smart coating 302 contains 7 grams of mesoporous silica nanocontainers, which provides about 11.9 g of MBT inhibitor.

For the multi-layer coating using the high load smart coating 304, 1 Kg of coating contains about 829 grams of mesoporous silica nanocontainers, which provides about 1409 g of MBT inhibitor. Thus, as illustrated in FIG. 3B, the loading of the inhibitor has increasing by 118 by weight from the high load smart coating 304. Table 2 are illustrating this comparison. Further layering can be achieved by multiple coating applications or a one-time application where the containers 102 are allowed to settle to the bottom of the high load smart coating 304 by rheological control.

TABLE 2
comparative example of Single-layer multi-functional vs multi-layer multi-functional coating

| | Single-layer multi- | Multi-layer multi- |
|---|---|---|
| | functional coating | functional coating |
| Structural example | FIG. 1A | FIG. 1B |
| Optimal mesoporous silica NCs loading by weight | 0.70% | 82.88% |
| Optimal mesoporous silica NCs loading by volume | 0.53% | 78.50% |
| Number of mesoporous silica NCs per 1 um3 | 20 | 2928 |
| Amount of mesoporous silica NCs gram per 1 Kg of coating | 7 | 829 |
| Amount MBT inhibitor per 1 Kg of coating, gram | 11.9 | 1409 |

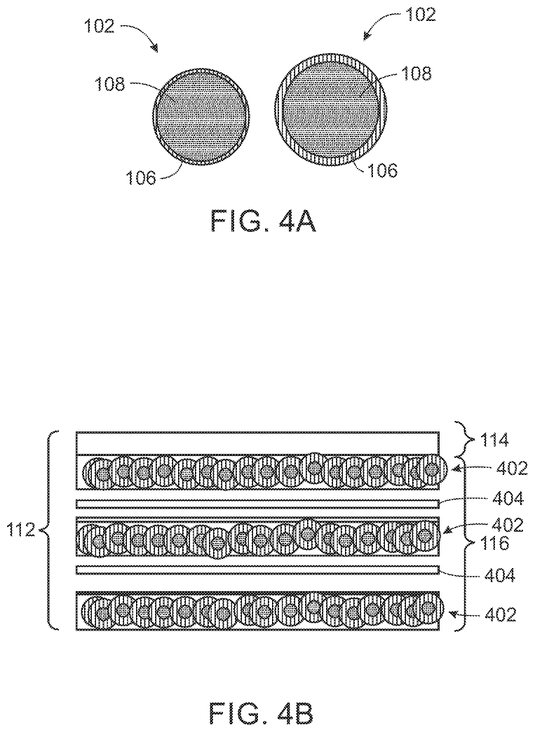

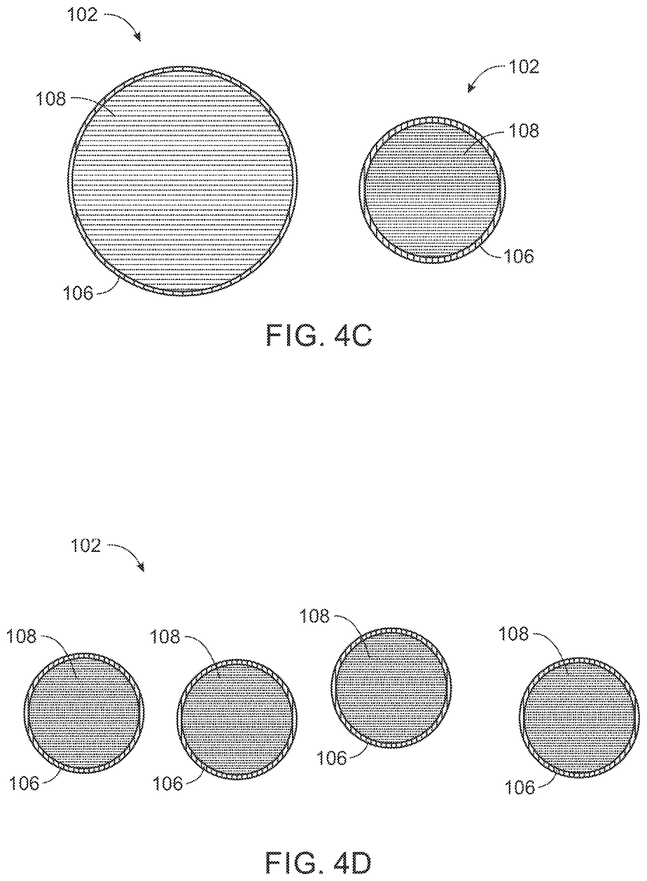

FIGS. 4A-4D are drawings that show different ways to adjust the operation of the high load smart coating 304. Like numbered items are as described with respect to FIGS. 1A and 1B. For example, controlling the thickness of the shell 106 of the container 102, as illustrated in FIG. 4A, can be used to provide different activation times. In this example, each of the containers 102 includes the same amount of corrosion inhibitor in the core 108. This may extend the life of the high load smart coating.

FIG. 4B illustrates another way to control the high load smart coating 116 by applying multiple layers of the high load smart coating as separate active layers 402. The active layers 402 can be separated by a tie or inter-coating layer 404. In some embodiments, the inter-coating layer 404 is designed to allow fluid to permeate through over time. For example, the inter-coating layer 404 may be formed from a polymer that is permeable to water vapor, such as polycarbonate, nylon, polystyrene, and the like. In other embodiments, the inter-coating layer 404 is formed from the same polymer as the matrix used in the active layers 402, adding further barrier functionality while maintaining corrosion protection.

As shown in FIG. 4C, the size of the containers 102 can be adjusted to hold different amounts of the inhibitor in the core 108. As the thickness and type of the shell 106 is not changed, the time to release of the inhibitor may be similar.

The activation of the containers 102, leading to release of the inhibitor, can be controlled by including containers having different materials used for the shell 106, as illustrated in FIG. 4D. For example, containers 102 can be included that have a shell 106 formed from nanotubes, mesoporous inorganic materials, oxide nano-particles, polyelectrolytes, layered double hydroxides, or any combinations thereof.

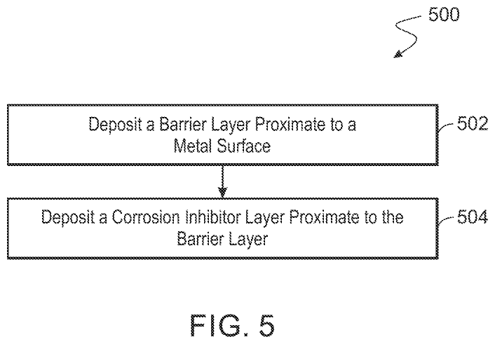

FIG. 5 is a process flow diagram of a method 500 for protecting a metal surface from corrosion. The method begins at block 502, when a barrier layer is deposited proximate to a metal surface. This can be directly over the metal surface, or over a protective metal coating that is applied first to the metal surface. The metal surface can be prepared to increase the adhesion of the barrier layer, for example, with an acid wash, a surface roughening, and the like.

At block 504, a corrosion inhibitor layer is deposited proximate to the barrier layer. The corrosion inhibitor layer is a high load smart coating, as described herein. In various embodiments, multiple corrosion inhibitor layers are deposited, for example, with an inter-coating layer deposited between each of the corrosion inhibitor layers.

### Embodiments

An embodiment described herein provides a multilayer protective coating. The multilayer protective coating includes a barrier layer and a corrosion inhibitor layer. The corrosion inhibitor layer includes particles that include a corrosion inhibitor.

In an aspect, combinable with any other aspect, the particles include greater than about 20 wt. % of the corrosion inhibitor layer.

In an aspect, the particles include greater than 50 wt. % of the corrosion inhibitor layer.

In an aspect, combinable with any other aspect, the multilayer protective coating includes at least two corrosion inhibitor layers, wherein each corrosion inhibitor layer is separated by a tie layer.

In an aspect, combinable with any other aspect, the corrosion inhibitor layer includes particles with both a larger diameter and particles with a smaller diameter.

In an aspect, combinable with any other aspect, the particles are selected from the group consisting of polymer containers, nanotubes, mesoporous inorganic materials, oxide nano-particles, nano-containers with polyelectrolyte shells, layered double hydroxides, and a combination thereof.

In an aspect, combinable with any other aspect, the barrier layer is disposed on a metal surface to be protected.

In an aspect, combinable with any other aspect, the barrier layer is disposed over a protective metal coating that is disposed over a metal surface to be protected.

In an aspect, combinable with any other aspect, a matrix of the barrier layer is selected from the group consisting of an epoxy, a polyurethane, a polyphenylene sulfide, a polyester, poly (phenylene methylene), silica, a phenolic resin, or any combination thereof.

In an aspect, combinable with any other aspect, the corrosion inhibitor layer is disposed over the barrier layer.

In an aspect, combinable with any other aspect, a matrix of the corrosion inhibitor layer is selected from the group consisting of epoxy, a polyurethane, a polyphenylene sulfide, a polyester, poly (phenylene methylene), silica, a phenolic resin, and any combination thereof.

In an aspect, combinable with any other aspect, the particles include active material embedded in a carrier.

In an aspect, combinable with any other aspect, the particles have a largest dimension of between about 50 nm and about 5 μm.

In an aspect, combinable with any other aspect, wherein the particles include a core and a shell disposed over the core.

In an aspect, combinable with any other aspect, including a mixture of particles with a thicker shell and particles with a thinner shell.

In an aspect, combinable with any other aspect, the core includes the corrosion inhibitor.

In an aspect, combinable with any other aspect, the core includes a solid, a droplet of liquids, or a gas, or a combination thereof.

In an aspect, combinable with any other aspect, the shell includes a polystyrene, a polyurethane, or a polyurea.

In an aspect, combinable with any other aspect, the carrier is selected from the group consisting of titanium dioxide, cerium dioxide, visa porous silica, nano, halloysite nanotubes, layered double hydroxide (LDH), multi-walled carbon nanotubes, or hydroxyapatite, or any combination thereof.

Another embodiment described herein provides a method for protecting a metal surface from corrosion. The method includes depositing a barrier layer proximate to a metal surface and depositing a corrosion inhibitor layer proximate to the barrier layer. The corrosion inhibitor layer includes particles that include a corrosion inhibitor.

In an aspect, combinable with any other aspect, the method includes preparing the metal surface to improve adhesion of the barrier layer or the corrosion inhibitor layer.

In an aspect, combinable with any other aspect, the method includes applying a protective metal coating over the metal surface before depositing the barrier layer.

In an aspect, combinable with any other aspect, the method includes forming the corrosion inhibitor layer by blending greater than about 50 wt. % particles into a binder.

In an aspect, combinable with any other aspect, the method includes depositing a tie layer after the corrosion inhibitor layer and depositing a second corrosion inhibitor layer over the tie layer.

Other implementations are also within the scope of the following claims.

What is claimed is:

1. A multilayer protective coating, comprising:
a barrier layer; and
a corrosion inhibitor layer, comprising particles that comprise a corrosion inhibitor.

2. The multilayer protective coating of claim 1, wherein the particles comprise greater than about 20 wt. % of the corrosion inhibitor layer.

3. The multilayer protective coating of claim 1, wherein the particles comprise greater than 50 wt. % of the corrosion inhibitor layer.

4. The multilayer protective coating of claim 1, comprising at least two corrosion inhibitor layers, wherein each corrosion inhibitor layer is separated by a tie layer.

5. The multilayer protective coating of claim 1, wherein the corrosion inhibitor layer comprises particles with both a larger diameter and particles with a smaller diameter.

6. The multilayer protective coating of claim 1, wherein the particles are selected from the group consisting of polymer containers, nanotubes, mesoporous inorganic materials, oxide nano-particles, nano-containers with polyelectrolyte shells, layered double hydroxides, and a combination thereof.

7. The multilayer protective coating of claim 1, wherein the barrier layer is disposed on a metal surface to be protected.

8. The multilayer protective coating of claim 1, wherein the barrier layer is disposed over a protective metal coating that is disposed over a metal surface to be protected.

9. The multilayer protective coating of claim 1, wherein a matrix of the barrier layer is selected from the group consisting of an epoxy, a polyurethane, a polyphenylene sulfide, a polyester, poly (phenylene methylene), silica, a phenolic resin, or any combination thereof.

10. The multilayer protective coating of claim 1, wherein the corrosion inhibitor layer is disposed over the barrier layer.

11. The multilayer protective coating of claim 1, wherein a matrix of the corrosion inhibitor layer is selected from the group consisting of epoxy, a polyurethane, a polyphenylene sulfide, a polyester, poly (phenylene methylene), silica, a phenolic resin, and any combination thereof.

12. The multilayer protective coating of claim 1, wherein the particles comprise active material embedded in a carrier.

13. The multilayer protective coating of claim 1, wherein the particles have a largest dimension of between about 50 nm and about 5 μm.

14. The multilayer protective coating of claim 12, wherein the particles comprise a core and a shell disposed over the core.

15. The multilayer protective coating of claim 14, comprising a mixture of particles with a thicker shell and particles with a thinner shell.

16. The multilayer protective coating of claim 14, wherein the core comprises the corrosion inhibitor.

17. The multilayer protective coating of claim 14, wherein the core comprises a solid, a droplet of liquids, or a gas, or a combination thereof.

18. The multilayer protective coating of claim 14, wherein the shell comprises a polystyrene, a polyurethane, or a polyurea.

19. The multilayer protective coating of claim 12, wherein the carrier is selected from the group consisting of titanium dioxide, cerium dioxide, visa porous silica, nano, halloysite nanotubes, layered double hydroxide (LDH), multi-walled carbon nanotubes, or hydroxyapatite, or any combination thereof.

20. A method for protecting a metal surface from corrosion, comprising:
depositing a barrier layer proximate to a metal surface; and
depositing a corrosion inhibitor layer proximate to the barrier layer, wherein the corrosion inhibitor layer comprises particles that comprise a corrosion inhibitor.

21. The method of claim 20, comprising preparing the metal surface to improve adhesion of the barrier layer or the corrosion inhibitor layer.

22. The method of claim 20, comprising applying a protective metal coating over the metal surface before depositing the barrier layer.

23. The method of claim 20, comprising forming the corrosion inhibitor layer by blending greater than about 50 wt. % particles into a binder.

24. The method of claim 20, comprising:
depositing a tie layer after the corrosion inhibitor layer; and
depositing a second corrosion inhibitor layer over the tie layer.
